(19) United States
(12) Patent Application Publication
(10) Pub. No.: US 2011/0299109 A1
(43) Pub. Date: Dec. 8, 2011

(54) IMAGE PROCESSING APPARATUS AND MANAGEMENT APPARATUS

(75) Inventors: Yoshikatsu Kamisuwa, Tokyo-to (JP); Hiroyo Katou, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/150,633

(22) Filed: Jun. 1, 2011

Related U.S. Application Data
(60) Provisional application No. 61/350,614, filed on Jun. 2, 2010.

(51) Int. Cl. G06K 15/00

(52) U.S. Cl. 358/1.14

(57) ABSTRACT

According to one embodiment, an image processing apparatus includes an error processing unit, a communication unit and an output unit. The error processing unit generates error information corresponding to detection of an error. The communication unit transmits the error information to a management apparatus and receives a diagnosis result from the management apparatus. The output unit outputs the diagnosis result.

### CROSS-REFERENCE TO RELATED APPLICATIONS

This application is based upon and claims the benefit of priority from U.S. Provisional Application No. 61/350,614, filed on Jun. 2, 2010; the entire contents of which are incorporated herein by reference.

### FIELD

Embodiments described herein relate generally to an image processing apparatus and a management apparatus.

### BACKGROUND

Various recent electronic apparatuses include help information presenting systems. When a trouble occurs in an electronic apparatus, the electronic apparatus can present an error code (code to express the state of the trouble) by the help information presenting system, or can present appropriate repair work content (so-called help information).

For example, a serviceman refers to a manual on hand based on the error code and can repair the electronic apparatus. In this case, the serviceman must carry the manual, and is required to be familiar with the use of the manual for effective repair work.

Alternatively, based on the error code, the serviceman accesses a help system opened to the public by a service center via the Internet through a Web browser, retrieves repair work information and can repair the electronic apparatus. In this case, the serviceman is required to carry a terminal, such as a notebook PC, for the repair work. Besides, since the disabled electronic apparatus is connected to the external network, the risk of information leakage from the electronic apparatus becomes high. For example, the disabled electronic apparatus is connected to the Internet or an intranet, and is set in a state where the apparatus can be accessed through the Internet or the intranet. The notebook PC connected to the Internet or the intranet reads various information from the electronic apparatus.

### BRIEF DESCRIPTION OF THE DRAWINGS

FIG. 1 is a block diagram showing an example of a schematic structure of an image processing apparatus of a first embodiment.

FIG. 2 is a sectional view showing an example of a schematic structure of an image processing apparatus of the first and a second embodiment.

FIG. 3 is a block diagram showing an example of a partial structure of the image processing apparatus of the first and the second embodiments and an example of a partial structure of a management apparatus.

FIG. 4 is a view showing an example of an error handling process (diagnosis process) of the first embodiment.

FIG. 5 is a block diagram showing an example of a schematic structure of an image processing apparatus of the second embodiment.

FIG. 6 is a view showing an example of an error handling process (diagnosis process) of the second embodiment.

### DETAILED DESCRIPTION

In general, according to one embodiment, an image processing apparatus includes an error processing unit, a communication unit and an output unit. The error processing unit generates error information corresponding to detection of an error. The communication unit transmits the error information to a management apparatus, and receives a diagnosis result from the management apparatus. The output unit outputs the diagnosis result.

Hereinafter, respective embodiments will be described with reference to the drawings.

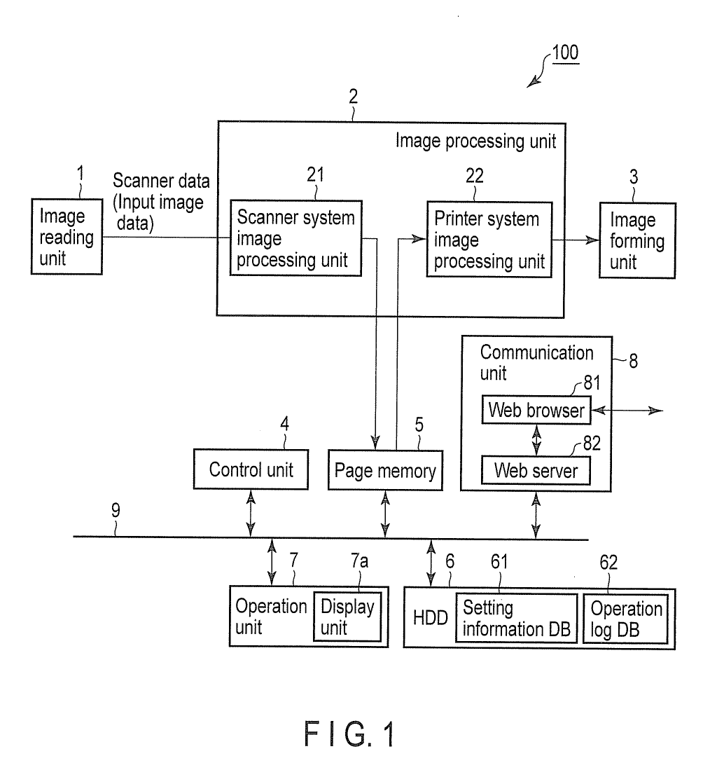

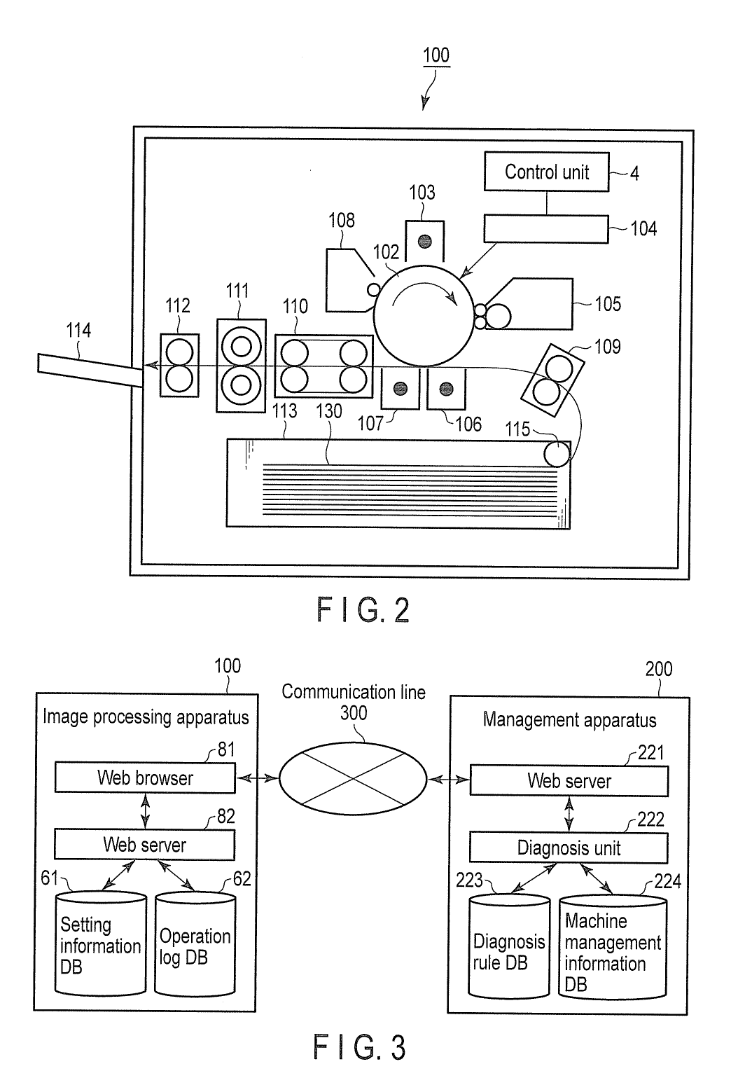

FIG. 1 is a block diagram showing an example of a schematic structure of an image processing apparatus of a first embodiment. FIG. 2 is a sectional view showing an example of a schematic structure of an image processing apparatus of the first and a second embodiments. FIG. 3 is a block diagram showing an example of a partial structure of the image processing apparatus of the first and the second embodiments and an example of a partial structure of a management apparatus.

The image processing apparatus shown in FIG. 1 to FIG. 3 is, for example, a multi function peripheral (MFP). In the respective embodiments described below, although an error handling process (diagnosis process) in the image processing apparatus will be described, the error handling process can be applied to various electronic apparatuses other than the image processing apparatus.

As shown in FIG. 1, an image processing apparatus 100 includes an image reading unit (scanner) 1, an image processing unit 2, an image forming unit (printer) 3, a control unit 4, a page memory 5, a data storage unit 6, an operation unit 7 and a communication unit 8. The control unit 4 is connected to the page memory 5, the data storage unit 6 and the like through a PCI bus 9 and the like.

The image reading unit 1 irradiates a light from a light source to a document image set on a document table by using a mirror and the like, detects the reflected light from the document image by a CCD or the like, and acquires input image data based on the detected reflected light.

The image processing unit 2 includes a scanner system image processing unit 21 and a printer system image processing unit 22. The scanner system image processing unit 21 analyzes the input image data (RGB data), and performs various image processes on the input image data based on the analysis result. The printer system image processing unit 21 converts the input image data into output image data (CMYK data).

The page memory 5 temporarily stores the input image data, the output image data and the like. The image forming unit 3 forms an image based on the output image data.

The control unit 4 controls the respective operations of the image reading unit 1, the image processing unit 2 and the image forming unit 3 based on instructions from the operation unit 7, and controls transmission and reception or the like of the image data between the image processing unit 2, the page memory 5 and the data storage unit 6. That is, the control unit 4 performs the control of reading the image of the document and the control of outputting the image or the like.

The data storage unit 6 is, for example, a hard disk drive (HDD), and stores the input image data, the output image data and the like. Besides, the data storage unit 6 stores an after-mentioned setting information database (DB) 61 and an operation log database (DB) 62.

The communication unit 8 is constructed to be capable of communicating with a management apparatus 200 through an external network. The communication unit 8 includes, for example, an after-mentioned Web browser 81 and a Web server 82.

The image processing apparatus 100 has a scanner function to read an image at a specified resolution, and a printer function to form an image on a sheet of a specified size at a specified resolution. Further, the image processing apparatus 100 may be a digital multi function peripheral. In this case, the image processing apparatus 100 has various functions of office equipments, such as an image receiving function by FAX, an image receiving function by E-mail, and a print image receiving function by network, in addition to the scanner function and the printer function.

As shown in FIG. 2, the image processing apparatus 100 includes the control unit 4, a photoconductive drum 102, a charging unit 103, a scanning exposure unit 104, a developing unit 105, a transfer charger 106, a peeling charger 107, a cleaner 108, a paper feed unit 109, a sheet conveyance unit 110, a fixing unit 111, a paper discharge unit 112, and a paper discharge tray 114.

The photoconductive drum 102 rotates in a sub-scanning direction (peripheral direction of the photoconductive drum 102). The charging unit 103 is disposed in the vicinity of the periphery of the photoconductive drum 102. The charging unit 103 uniformly charges the surface of the photoconductive drum 102. The scanning exposure unit 104 turns on and off a light according to an image signal while a semiconductor laser in the scanning exposure unit 104 scans. The laser light emitted from the semiconductor laser becomes the light to scan in a main scanning direction (rotation axis direction of the photoconductive drum 102) by a deflecting unit such as a polygon mirror. The laser light is irradiated onto the photoconductive drum 102 by an optical system such as a lens. When the laser light is irradiated to the charged photoconductive drum 102, the potential of an irradiated unit is reduced, and an electrostatic latent image is formed.

The developing unit 105 applies a developer to the photoconductive drum 102 and forms a toner image on the photoconductive drum 102. On the other hand, a sheet tray 113 is provided at the bottom of the image processing apparatus 100. A paper feed roller 115 separates sheets 130 in the sheet tray 113 one by one, and sends the sheet to the paper feed unit 109. The paper feed unit 109 supplies the sheet 130 to the transfer position of the photoconductive drum 102. The transfer charger 106 transfers the toner image to the supplied sheet 130. The peeling charger 107 peels the sheet 130 from the photoconductive drum 102.

The sheet 130 on which the toner image is transferred is conveyed by the sheet conveyance unit 110. The fixing unit 111 fixes the toner image to the sheet 130. The paper discharge unit 112 discharges the sheet 130 on which the image is printed to the paper discharge tray 114.

After the transfer of the toner image to the sheet 130 is ended, the remaining toner on the photoconductive drum 102 is removed by the cleaner 108. The photoconductive drum 102 returns to the initial state, and is placed in a standby state for next image formation.

The image forming operation continues by repeating the above process operation.

### First Embodiment

Hereinafter, an error handling process of the first embodiment will be described.

As shown in FIG. 3, the image processing apparatus 100 is constructed to be capable of communicating with the management apparatus 200 through a communication line 300. As described above, the image processing apparatus 100 includes the Web browser 81. The Web browser 81 accesses a public Web server 221 of the management apparatus 200 at a remote place, transmits, for example, an error code (error information) after an authentication process using a password, and calls a diagnosis program of a diagnosis unit 222. The Web server 221 receives the error code, provides the error code to the diagnosis unit 222, and calls the diagnosis program of the diagnosis unit 222.

Besides, the Web browser 81 accesses the Web server 82, accesses the setting information DB 61 and the operation log DB 62 through the Web server 82, reads setting information, operation log and the like from the setting information DB 61 and the operation log DB 62, and transmits the setting information, the operation log and the like to the Web server 221 of the management apparatus 200. The Web server 82 includes an interface to the setting information DB 61 and the operation log DB 62, receives the access from the Web browser 81 of the image processing apparatus 100, and accesses the setting information DB 61 and the operation log DB 62 after an authentication process using a password.

The public Web server 221 of the management apparatus 200 limits an access from the outside by an authentication process using a password. The Web server 221 receives the setting information and the operation log transmitted from the Web browser 81 after the authentication process using the password, and provides the setting information and the operation log to the diagnosis unit 222. The diagnosis unit 222 starts a diagnosis program, diagnoses an error based on the setting information and the operation log, and generates help information based on a diagnosis result. The Web server 221 transmits the diagnosis result to the Web browser 81.

The diagnosis unit 222 includes an interface for accessing a diagnosis rule database (DB) 223 and a machine management information database (DB) 224 to store setting information, operation logs and the like transmitted in the past, calls a diagnosis rule based on the error code, the setting information and the operation log, and diagnoses (operates) the error.

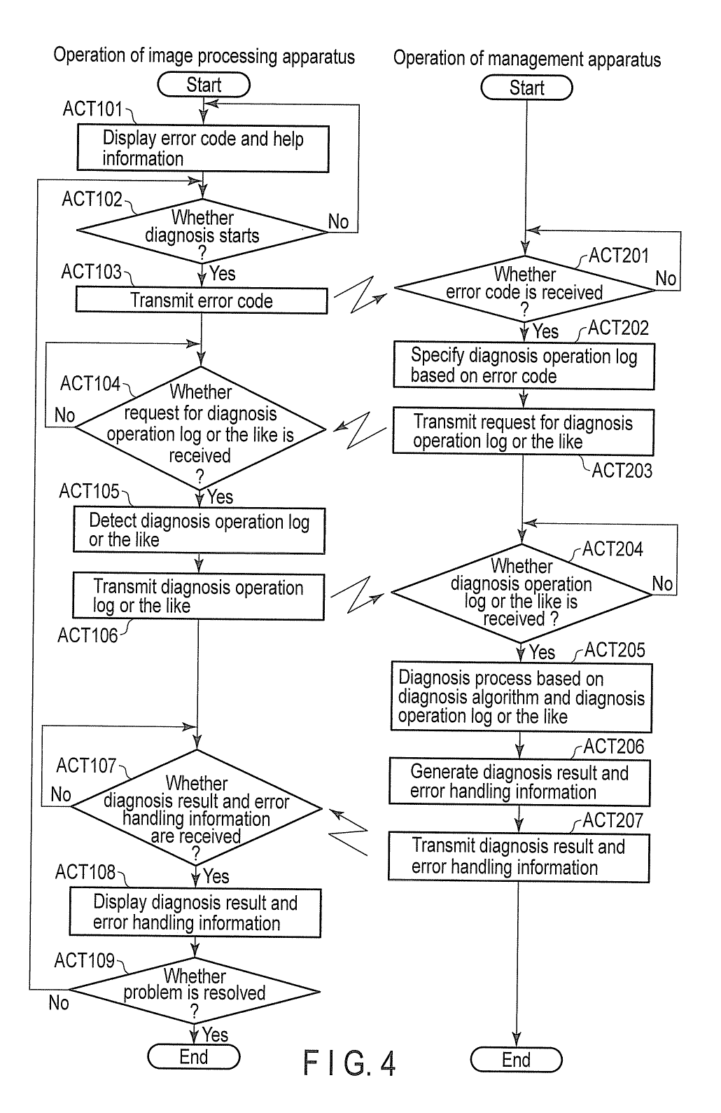

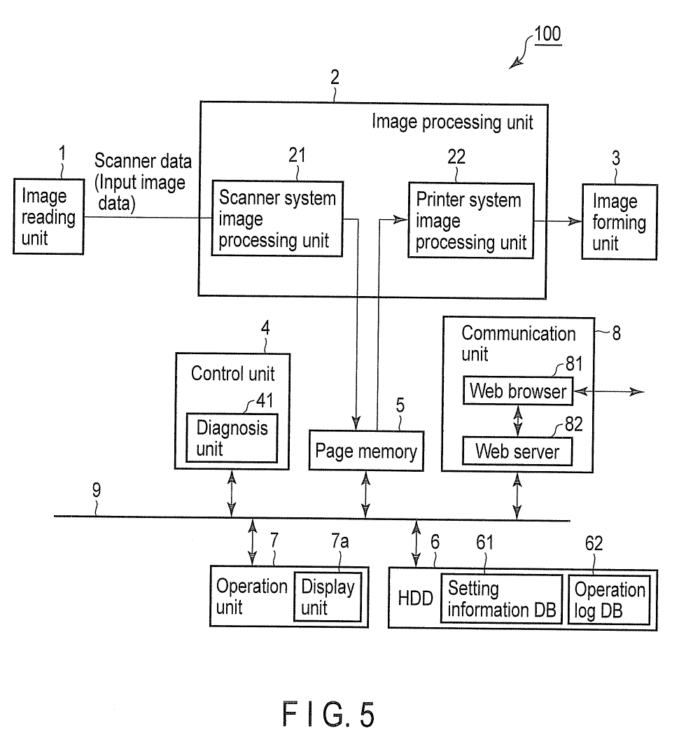

The error handling process (diagnosis process) of the first embodiment will be described in more detail with reference to FIG. 4.

When the control unit 4 of the image processing apparatus 100 detects an error based on signals from respective sensors provided in the image processing apparatus 100, the control unit generates an error code (error information) corresponding to the detection of the error. For example, when the control unit 4 detects an error of a sheet conveyance system, the control unit generates an error code corresponding to the error of the sheet conveyance system. When the control unit 4 detects an error of an exposure system, the control unit generates an error code corresponding to the error of the exposure system. Further, the control unit 4 instructs the display of the error code. In response to this, the display unit 7a displays the error code, and displays help information corresponding to the error code (ACT 101).

When the control unit 4 can not generate an error code corresponding to the detection of the error, the control unit instructs the output of a message requesting the input of an error symptom corresponding to the detection of the error. In response to this, a display unit 7a displays the message requesting the input of the error symptom. In accordance with the message of the display unit 7a, the user can input the error symptom through the control unit 7. For example, the user can input such an error symptom that a streak is recorded on a sheet on which an image is printed. The control unit 4 can generate an error code based on the input of the error symptom. Also in this case, similarly to the above, the control unit 4 instructs the display of the error code. In response to this, the display unit 7a displays the error code and displays help information corresponding to the error code (ACT 101).

For example, when the user selects a diagnosis start key (touch key) on the display unit 7a, the control unit 4 starts a diagnosis process (ACT 102, YES), and instructs transmission of an error code. In response to this, the Web browser 81 transmits the error code to the management apparatus 200 (ACT 103).

The Web server 221 of the management apparatus 200 receives the error code (ACT 201, YES), and the diagnosis unit 222 specifies the diagnosis setting information and the diagnosis operation log for diagnosing the error based on the received error code (ACT 202). That is, the diagnosis unit 222 derives the diagnosis setting information and the diagnosis operation log necessary for diagnosing the error indicated by the error code. For example, the diagnosis rule DB 223 stores a list indicating a relation between each error code, setting information and operation log. The diagnosis unit 222 refers to the list, and specifies the diagnosis setting information and the diagnosis operation log necessary for diagnosing the error indicated by the received error code. At this time, for example, the diagnosis unit 222 specifies also a diagnosis algorithm (diagnosis program) based on the received error code. For example, the diagnosis rule DB 223 stores a list indicating a relation between each error code and each diagnosis algorithm (diagnosis program). The diagnosis unit 222 refers to the list, and specifies the diagnosis algorithm necessary for diagnosing the error indicated by the received error code. The diagnosis algorithm and the diagnosis program are generically defined as diagnosis data. The Web server 221 transmits a request for the specified diagnosis setting information and the diagnosis operation log to the image processing apparatus 100 (ACT 203).

The Web browser 81 of the image processing apparatus 100 receives the request for the diagnosis setting information and the diagnosis operation log (ACT 104, YES), and the Web server 82 detects (selects) the requested diagnosis setting information and the diagnosis operation log from the setting information DB 61 and the operation log DB 62 (ACT 105). For example, the setting information DB 61 stores a lot of setting information, and the Web server 82 selects the requested diagnosis setting information from a lot of the setting information stored in the setting information DB 61. Similarly, the operation log DB 62 stores many operation logs, and the Web server 82 selects the requested diagnosis operation log from the many operation logs stored in the operation log DB 62. For example, the setting information DB 61 stores a vast number of setting information such as information relating to a sheet feed speed, information relating to a writing position on a sheet, and information relating to an exposure potential of the photoconductive drum. Similarly, the operation log DB 62 stores a vast number of operation logs such as information relating to a sheet conveyance time and information relating to the surface potential of the photoconductive drum.

As stated above, when the requested diagnosis setting information and the diagnosis operation log are selected, the Web browser 81 transmits the diagnosis setting information and the diagnosis operation log to the management apparatus 200 (ACT 106).

The Web server 221 of the management apparatus 200 receives the diagnosis setting information and the diagnosis operation log (ACT 204, YES), and provides the diagnosis setting information and the diagnosis operation log to the diagnosis unit 222. The diagnosis unit 222 stores the diagnosis setting information and the diagnosis operation log in the machine management information DB 224. Further, the diagnosis unit 222 selects the diagnosis program stored in the diagnosis rule DB 223 in order to execute the diagnosis program specified based on the received error code, and executes the diagnosis process based on the diagnosis program, the diagnosis setting information and the diagnosis operation log (ACT 205). The diagnosis unit 222 diagnoses the error, and generates the diagnosis result and error handling information (ACT 206). The Web server 221 transmits the diagnosis result and the error handling information to the image processing apparatus 100 (ACT 207).

The Web browser 81 of the image processing apparatus 100 receives the diagnosis result and the error handling information (ACT 107, YES), and the control unit 4 instructs the display of the diagnosis result and the error handling information. In response to this, the display unit 7a displays the diagnosis result and the error handling information (ACT 108). When the problem of the error occurrence is not resolved based on the diagnosis result and the error handling information (ACT 109, NO), the user again selects the diagnosis start key (touch key) on the display unit 7a (ACT 103, YES), and can repeat the above diagnosis process. In this case, for example, in view of the fact that the process is not the first diagnosis process (second or later diagnosis process), the control unit 4 searches for a cause of the error different from the first, and generates an error code different from the first.

When the problem of the error occurrence is resolved based on the content of the diagnosis result (ACT 109, YES), the error handling process is ended.

In the above description, although the description is made on the case where the management apparatus 200 requests both the diagnosis setting information and the diagnosis operation log, there is also a case where one of them is requested. In this case, the image processing apparatus 100 transmit one of them in response to the request for one of them.

Besides, in the description, although the description is made on the case where the management apparatus 200 transmits both the diagnosis result and the error handling information, there is also a case where one of them is transmitted. In this case, the image processing apparatus 100 displays one of them.

Besides, in the description, although the description is made on the case where the management apparatus 200 generates the error handling information, the image processing apparatus 100 may generate the error handling information. For example, the data storage unit 6 of the image processing apparatus 100 stores the correspondence data indicating the correspondence between the diagnosis result and the error handling information, and the management apparatus transmits the diagnosis result to the image processing apparatus 100. The image processing apparatus 100 receives the diagnosis result from the management apparatus 200, refers to the correspondence data, and generates the error handling information based on the diagnosis result.

According to the above-described first embodiment, the image processing apparatus 100 can obtain the appropriate diagnosis result and the error handling information, and can display the appropriate diagnosis result and the error handling information.

For example, even when the arithmetic performance of the image processing apparatus 100 is not sufficient for the diagnosis process or the like, when the arithmetic performance of the management apparatus 200 is sufficient for the diagnosis process and the like, the image processing apparatus 100 can obtain the appropriate diagnosis result or the like, and can display the appropriate diagnosis result or the like. That is, even when the image processing apparatus 100 does not include a high performance arithmetic unit, when the management apparatus 200 includes a high performance arithmetic unit, the image processing apparatus 100 can obtain the appropriate diagnosis result or the like, and can display the appropriate diagnosis result or the like.

Besides, even when a diagnosis algorithm is not decided at the time of release of the image processing apparatus 100, when an appropriate diagnosis algorithm is set for the management apparatus 200, the image processing apparatus 100 can obtain the appropriate diagnosis result or the like based on the appropriate diagnosis algorithm, and can display the appropriate diagnosis result or the like.

Besides, even when a diagnosis algorithm is changed or updated after the release of the image processing apparatus 100, when the changed or updated diagnosis algorithm is set for the management apparatus 200, the image processing apparatus 100 can obtain the appropriate diagnosis result or the like based on the changed or updated diagnosis algorithm, and can display the appropriate diagnosis result or the like.

Besides, even when various parameters, thresholds or the like for diagnosis are not decided at the time of release of the image processing apparatus 100, when various appropriate parameters, thresholds or the like are set for the management apparatus 200, the image processing apparatus 100 can obtain the appropriate diagnosis result or the like based on the various appropriate parameters, thresholds or the like, and can display the appropriate diagnosis result or the like.

As stated above, when the management apparatus 200 manages the diagnosis algorithm (diagnosis program), the diagnosis process or the like based on the newest diagnosis algorithm can be executed.

Further, the management apparatus 200 specifies the diagnosis setting information and the diagnosis operation log for diagnosing the error based on the error code, and requests the diagnosis setting information and the diagnosis operation log. By this, the image processing apparatus 100 need not transmit all setting information and all operation logs (need not transmit vast data), and the image processing apparatus has only to transmit only necessary information (diagnosis setting information and diagnosis operation log) at necessary timing. Besides, the image processing apparatus 100 need not transmit diagnosis setting information and diagnosis operation log periodically. By this, the communication traffic can be reduced, and the management apparatus 200 need not receive and store unnecessary information.

Besides, the image processing apparatus 100 restricts only to the access from the Web browser 81 embedded in the image processing apparatus 100 to the Web server 82, and can improve security.

From the above, the image processing apparatus 100 with less risk of information leakage can be provided.

### Second Embodiment

Hereinafter, an error handling process of a second embodiment will be described. Different portions between the second embodiment and the first embodiment will be mainly described and description of common portions will be omitted.

FIG. 5 is a block diagram showing an example of a schematic structure of an image processing apparatus of the second embodiment. As shown in FIG. 5, the control unit 4 of the image processing apparatus 100 of the second embodiment includes a diagnosis unit 41.

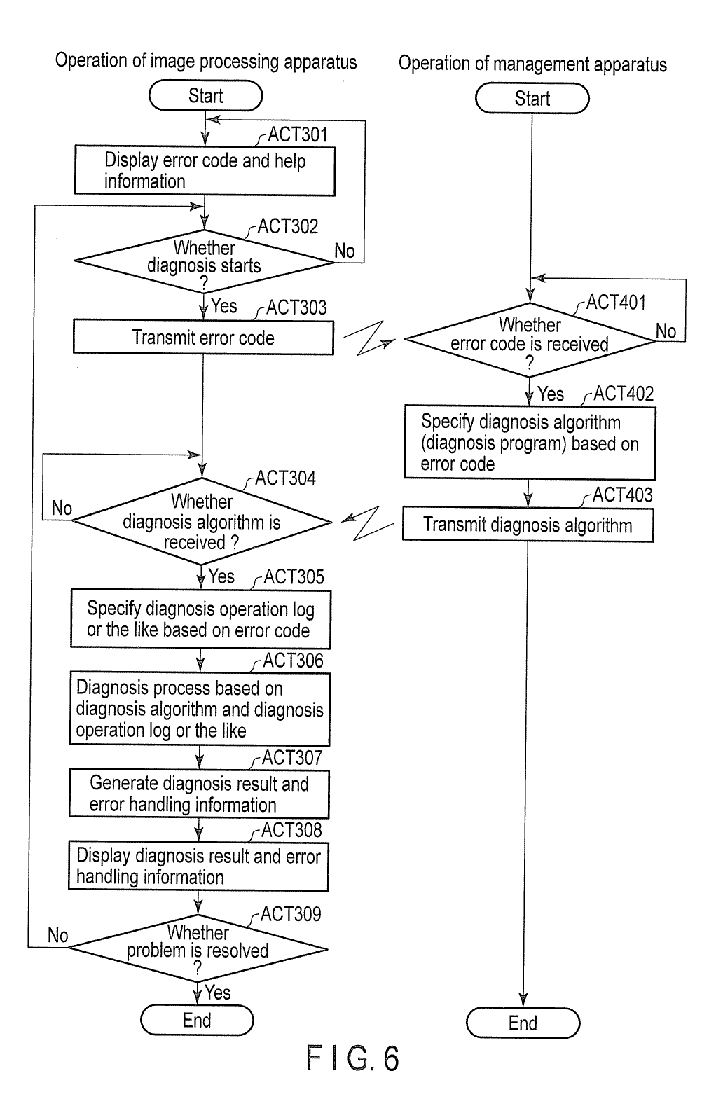

The error handling process (diagnosis process) of the second embodiment will be described in detail with reference to FIG. 6.

When the control unit 4 of the image processing apparatus 100 detects an error based on signals from respective sensors provided in the image processing apparatus 100, the control unit generates an error code (error information) corresponding to the detection of the error. Further, the control unit 4 instructs display of the error code. In response to this, the display unit 7a displays the error code, and displays help information corresponding to the error code (ACT 301).

When the control unit 4 can not generate the error code corresponding to the detection of the error, the control unit instructs output of a message requesting input of an error symptom corresponding to the detection of the error. In response to this, the display unit 7a displays the message requesting the input of the error symptom. In accordance with the message of the display unit 7a, the user can input the error symptom through the operation unit 7. For example, the user can input such an error symptom that a streak is recorded on a sheet on which an image is printed. The control unit 4 can generate an error code based on the input of the error symptom. Also in this case, similarly to the above, the control unit 4 instructs display of the error code. In response to this, the display unit 7a displays the error code, and displays help information corresponding to the error code (ACT 301).

For example, when the user selects a diagnosis start key (touch key) on the display unit 7a, the control unit 4 starts a diagnosis process (ACT 302, YES), and instructs transmission of the error code. In response to this, the Web browser 81 transmits the error code to the management apparatus 200 (ACT 303).

The Web server 221 of the management apparatus 200 receives the error code (ACT 401, YES), and the diagnosis unit 222 specifies a diagnosis algorithm (diagnosis program) based on the received error code (ACT 402). That is, the diagnosis unit 222 derives the diagnosis algorithm (diagnosis program) necessary for diagnosing the error indicated by the error code. For example, the diagnosis rule DB 223 stores a list indicating a relation between each error code and each diagnosis algorithm (diagnosis program). The diagnosis unit 222 refers to the list and specifies the diagnosis algorithm necessary for diagnosing the error indicated by the received error code. Incidentally, the above diagnosis algorithm and the diagnosis program are generically defined as diagnosis data. The Web server 221 transmits the specified diagnosis algorithm to the image processing apparatus 100 (ACT 403).

The Web browser 81 of the image processing apparatus 100 receives the specified diagnosis algorithm (ACT 304, YES). The diagnosis unit 41 of the control unit 4 specifies diagnosis setting information and diagnosis operation log for diagnosing the error based on the error code (ACT 305). That is, the diagnosis unit 41 drives the diagnosis setting information and the diagnosis operation log necessary for diagnosing the error indicated by the error code. For example, the data storage unit 6 stores a list indicating a relation between each error code, setting information and operation log. The diagnosis unit 41 refers to the list, and specifies the diagnosis setting information and the diagnosis operation log necessary for diagnosing the error indicated by the error code. Further, the diagnosis unit 41 detects (selects) the specified diagnosis setting information and the diagnosis operation log from the setting information DB 61 and the operation log DB 62.

The diagnosis unit 41 executes a diagnosis process based on the received diagnosis algorithm (diagnosis program), the diagnosis setting information and the diagnosis operation log (ACT 306). The diagnosis unit 41 diagnoses the error, and generates a diagnosis result and error handling information (ACT 307). The control unit 4 instructs display of the diagnosis result and the error handling information. In response to this, the display unit 7a displays the diagnosis result and the error handling information (ACT 308). When the problem of the error occurrence is resolved based on the content of the diagnosis result (ACT 309, YES), the error handling process is ended.

In the description, although the description is made on the case where the diagnosis unit 41 specifies both the diagnosis setting information and the diagnosis operation log, one of them may be specified. Besides, although the description is made on the case where the diagnosis unit 41 generates both the diagnosis result and the error handling information, one of them may be generated.

According to the above-described second embodiment, the image processing apparatus 100 can obtain the appropriate diagnosis result and the error handling information. Besides, the appropriate diagnosis result and the error handling information can be displayed.

For example, even when the diagnosis algorithm is not decided at the time of release of the image processing apparatus 100, the appropriate diagnosis algorithm is transmitted from the management apparatus 200 to the image processing apparatus 100. Thus, the image processing apparatus 100 can obtain the appropriate diagnosis result or the like based on the appropriate diagnosis algorithm and can display the appropriate diagnosis result or the like.

Besides, even when the diagnosis algorithm is changed or updated after the release of the image processing apparatus 100, the management apparatus 200 transmits the changed or updated diagnosis algorithm to the image processing apparatus 100. Thus, the image processing apparatus 100 can obtain the appropriate diagnosis result or the like based on the changed or updated diagnosis algorithm and can display the appropriate diagnosis result or the like.

Besides, even when various parameters, thresholds or the like for diagnosis are not decided at the time of release of the image processing apparatus 100, the management apparatus 200 sets various appropriate parameters, thresholds or the like in the image processing apparatus 100. Thus, the image processing apparatus 100 can obtain the appropriate diagnosis result or the like based on the various appropriate parameters, thresholds or the like and can display the appropriate diagnosis result or the like.

As described above, since the management apparatus 200 detects the appropriate diagnosis algorithm (diagnosis program) corresponding to the error code, and transmits the diagnosis algorithm to the image processing apparatus 100, the image processing apparatus 100 can execute the diagnosis process and the like based on the newest diagnosis algorithm.

Besides, the image processing apparatus 100 need not transmit the setting information and the operation log to the management apparatus 200. By this, the communication traffic can be reduced, and the management apparatus 200 need not receive and store unnecessary information. Further, the leakage of the setting information and the operation log can be prevented.

Besides, the image processing apparatus 100 restricts only to the access from the Web browser 81 embedded in the image processing apparatus 100 to the Web server 82, and can improve security.

From the above, the image processing apparatus 100 with less risk of information leakage can be provided.

The image processing apparatus of at least one of the embodiments described above can handle the error efficiently and safely. Besides, the management apparatus of at least one of the embodiments can provide the information for handling the error efficiently and safely.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an error processing unit to generate error information corresponding to detection of an error;
a communication unit that transmits the error information to a management apparatus, and receives a diagnosis result from the management apparatus; and
an output unit to output the diagnosis result.

2. The apparatus of claim 1, wherein the communication unit receives a request for a diagnosis operation log necessary for diagnosing the error and derived based on the error information from the management apparatus, and transmits the diagnosis operation log to the management apparatus.

3. The apparatus of claim 2, wherein the communication unit receives the request for the diagnosis operation log sent back from the management apparatus in response to the transmission of the error information.

4. The apparatus of claim 2, further comprising
a storage unit to store a plurality of operation logs, wherein
the error processing unit selects the diagnosis operation log from the plurality of operation logs stored in the storage unit.

5. The apparatus of claim 2, wherein the communication unit receives the diagnosis result sent back from the management apparatus in response to the transmission of the diagnosis operation log.

6. The apparatus of claim 1, wherein the output unit displays error handling information based on the diagnosis result.

7. The apparatus of claim 1, wherein the error processing unit generates the error information based on input information from a user.

8. A management apparatus comprising:
a diagnosis processing unit to diagnose an error based on error information; and
a communication unit that receives the error information from an image processing apparatus and transmits a diagnosis result to the image processing apparatus.

9. The apparatus of claim 8, wherein the diagnosis processing unit derives a diagnosis operation log for diagnosing the error based on the error information,
the communication unit transmits a request for the diagnosis operation log to the image processing apparatus and receives the diagnosis operation log from the image processing apparatus, and
the diagnosis processing unit diagnoses the error based on the diagnosis operation log.

10. An image processing apparatus comprising:
an error processing unit to generate error information corresponding to detection of an error;
a communication unit that transmits the error information to a management apparatus and receives diagnosis data corresponding to the error information from the management apparatus;
a diagnosis unit to diagnose the error based on the diagnosis data; and
an output unit to output a diagnosis result.

11. The apparatus of claim 10, wherein the diagnosis unit selects a diagnosis operation log for diagnosing the error based on the error information, and diagnoses the error based on the diagnosis data and the diagnosis operation log.

12. The apparatus of claim 11, further comprising
a storage unit to store a plurality of operation logs, wherein
the diagnosis unit selects the diagnosis operation log from the plurality of operation logs stored in the storage unit.

13. The apparatus of claim 10, wherein the communication unit receives a diagnosis program corresponding to the error information from the management apparatus, and
the diagnosis unit diagnoses the error based on the diagnosis program.

14. The apparatus of claim 10, wherein the output unit displays error handling information based on the diagnosis result.

15. The apparatus of claim 10, wherein the error processing unit generates the error information based on input information from a user.
